(19) United States
(12) Patent Application Publication
(10) Pub. No.: US 2004/0119192 A1
(43) Pub. Date: Jun. 24, 2004

(54) Method for producing a touch-and-close fastener element

(76) Inventor: Jan Tuma, Berlin (DE)

Correspondence Address: Mark S Bicks, Roylance Abrams Berdo & Goodman, Suite 600, 1300 19th Street NW, Washington, DC, 20036, US

(21) Appl. No.: 10/476,458

(22) PCT Filed: Apr. 25, 2002
(86) PCT No.: PCT/EP02/04553

(30) Foreign Application Priority Data
May 12, 2001 (DE) 101 23 206.3

(51) Int. Cl. B32B 31/30

(52) U.S. Cl. 264/167; 264/171.13; 264/171.14; 264/171.23

(57) ABSTRACT

The invention relates to a method for producing a touch-and-close fastener element (18) comprising a multitude of hook means (16), which are provided with a support (26) as one piece. In order to form said support (26), a plastic material in a free-flowing state is fed to a gap (22) located between a pressing device (24) and a shaping device (10) that is provided with cavities (14) for shaping the respective hook means (16). A support (26) having a small thickness can be obtained and/or the removal of the support (26) from the shaping device (10) is facilitated by feeding the plastic material together with the supporting part (32) into the gap (22), whereby the supporting part bears the support (26) between the pressing device (24) and the plastic material.

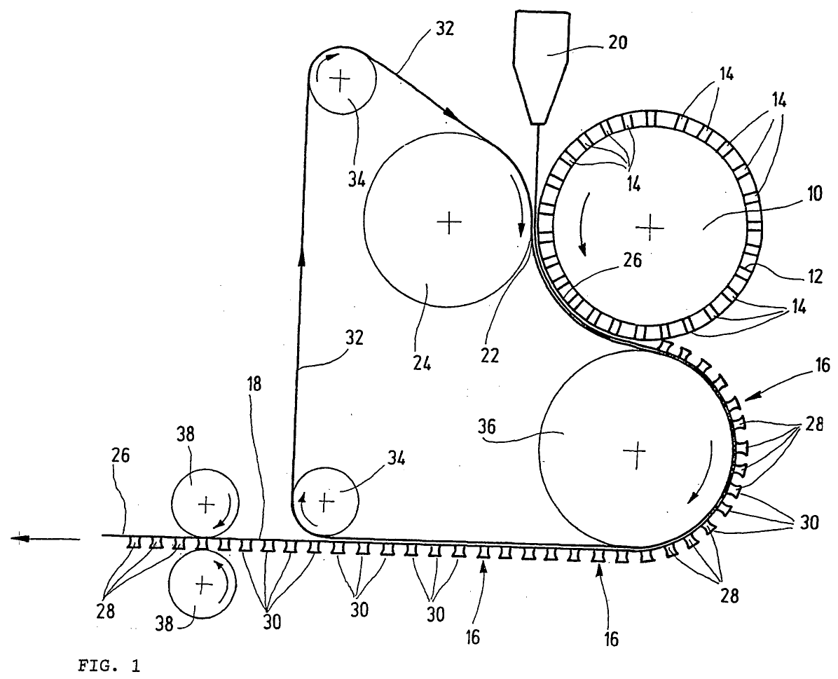

The invention relates to a method for producing a touch-and-close fastener element having a plurality of interlocking means integral with a backing, a process in which, for the purpose of forming a backing, a plastic material in a free-flowing state is fed to a gap which is situated between a pressing device and a shaping device and which is provided with cavities for shaping the respective interlocking means.

In a generic process as disclosed in DE 196 46 318 A1, for the purpose of producing a fastener element having a plurality of interlocking means in the form of enlargements (interlocking heads) integral with the backing, a thermoplastic material in the plastic or liquid state is introduced into a gap between a press roller and a shaping roller, such shaping roller being provided with cavities open outward and inward and both rollers being rotated in opposite directions, so that the backing is formed in the gap between the rollers. The shaping roller as disclosed also has a screen the cavities of which are produced preferably by etching or by means of a laser, the finished interlocking means being produced exclusively as a result of at least partial setting of the thermoplastic material in the open cavities of the shaping roller. The thermoplastic material used preferably is a polypropylene, polyamide, or polyethylene, and also one or more of these plastics containing copolymers or terpolymers. The enlargements of the stalks are in the form of mushrooms having flattened or concave recesses.

This disclosed process may be applied for very cost-effective production of fastener elements of high quality which, while forming conventional fasteners used in conjunction with corresponding fastener elements which may have comparably designed interlocking means or are formed with a finish or loop material. While the fastener element produced in this way is flexible and may be adapted to various geometric shapes, the fastener is not characterized to a significant extent by inherent elasticity behavior, that is, the fastener element produced in this way by casting or extrusion essentially retains its assigned external shape and cannot be stretched elastically to a significant extent. However, the elastic properties involved are desirable in fastening systems as well, for example, if in the area of orthopedics or sports medicine bandages are to be applied elastically to parts of the body and then, in addition to performing a support function, are still to be elastic enough so that they do not impair the wearers of such bandages and support elements. In addition, elastic fastener systems are especially well suited for holding cables of cable harnesses together and so may be used in the automotive, aircraft, and shipbuilding fields. In contrast to the fastener systems described, the customary clamplike cable connectors, use of which still predominates at present, both are difficult to install and cannot be detached without being destroyed.

An elastic fastener system in which individual interlocking means in the form of catch hooks mounted on a thin elastic plastic backing has already been described in WO 95/10202. However, the production process involved is complex and consequently cost-intensive. In addition, interlocking means of any given design cannot be connected to the elastic backing element by the process disclosed. Since the interlocking means also are only mounted on the elastically extensible foil, the interlocking means are not integral with the backing. This could result in separation of the interlocking means if a high force is applied to the fastening system.

PCT publications WO99/17630 and WO99/17631 also describe an elastic fastener, one in which a relatively rigid and stiff plastic material for the interlocking means is mounted as a layer on another layer of an elastic plastic foil, the layer materials themselves being rigidly interconnected. In order for the interlocking means then to be able to move elastically with the foil layer, the rigid layer material with the interlocking means is separated preferably by cutting, so that the interlocking means then move away from each other as the elastic foil is stretched and may then return until the adjacent areas of the rigid layer material come in contact with each other again. The production processes involved are complex and cost-intensive and, since a plurality of layer materials is used, the thickness of the elastic fastener element is correspondingly great. Consequently, this disclosed system does not appear to be suitable for use for so-called microfasteners, which are geometrically very small. It is also not to be excluded that the layers may be separated over a prolonged period of use and if greater force is applied, this rendering this disclosed fastener system unusable.

On the basis of this state of the art the invention has the object of further improving the disclosed processes for production of an elastic fastener element, in particular of providing a cost-effective and reliable process for production of such fasteners which remain serviceable even after a long period of use and when subjected to application of high forces. The invention also has the object of providing fastener elements such as this as microfasteners of elastic design. The object as formulated is attained by the characteristics specified in claim 1 and/or claim 2 in their entirety.

In that, as specified in the characterizing part of claim 1, in addition to the plastic material fed to the gap, a support element is introduced which supports the backing between the pressing device and the plastic material in such a way that this backing is made thin enough during shaping of the interlocking means so that the backing is provided with a suitable plastic material of predetermined extensibility or elasticity, integration of the interlocking means with the backing during the shaping process being ensured. It is accordingly made certain that the interlocking means cannot be unintentionally separated from the backing in the form of a strip or sheet even over a prolonged period of use and application of high forces, conditions which otherwise might render the fastener system unusable.

Since the support element absorbs a large part of the forces of pressure introduced by the pressing device during shaping, the backing, in the form of an extensible or elastic element, may be designed to be very thin, so that elastic microfasteners or ones of high extensibility may be made in the process claimed for the invention. The very thin configuration of the backing also benefits the elasticity values of the latter, so that very good elasticity properties may be provided. Very high production speeds can be reached with the process claimed for the invention, so that to this extent the elastic fastener element may be obtained with high cost-effectiveness.

In that, as specified in the characterizing part of claim 2, in addition to the plastic material introduced into the gap in this material, a support element is also introduced which supports the backing between the pressing device and the plastic material in such a way that a separable connection to the support element is intermittently formed, very high supporting forces are reached during shaping by the adherent connection, and in addition the adherent force may be used to form the interlocking means reliably and as intended with their undercuts from the moulding cavities of the shaping device. The forced removal from the moulding device involved makes certain that the interlocking means do not remain in the moulding cavities, something which could severely disrupt the production process. It is also made certain that the counterforces introduced by way of the support element do not unintentionally result in separation of the interlocking means, since the latter may be removed from the cavities by gentle forces. Consequently, use of the support element is advisable in other applications as well in which undercuts are assigned to the shaping tool in shaping of the interlocking means, for example, in order to be able to mould a conventional hooked shape or the like. It is also possible in situations such as these to design the backing material to be very thick so that very small interlocking means are then mounted integrally on a thick backing material, something which may be advisable for specific modes of application.

In another preferred embodiment of the process claimed for the invention a plastic foil, preferably a polyester foil, polypropylene foil, or polyamide foil, is used as the support element. However, a thin metal foil, such as an aluminum foil, may also be used as the support element. The support element may be used repeatedly in a closed circuit especially when metal foils are employed, so that nothing is wasted. This both benefits the environment and contributes to lowering of the production costs of the system.

Any desired shape may be produced as interlocking means, as for example interlocking heads, catch hooks, mushrooms, or preforms on interlocking means such as stalk material the free head ends of which may be reshaped to produce interlocking heads in a subsequent shaping process, in a calendering process, for example.

It has also been found to be especially advantageous to use as pressing and shaping device a press roller and shaping roller rotating in opposite directions, the respective rollers being heated for the shaping process. If the plastic material introduced for shaping is a thermoplastic polyurethane material, favorable bonding with the support element is achieved for the shaping process, but after such shaping the bond can be severed again without any difficulty in order to obtain the elastic fastener element.

The process claimed for the invention is described in greater detail in what follows on the basis of an exemplary embodiment. The sole FIGURE illustrates the device for application of the process in a diagram not drawn to scale.

The FIGURE shows a shaping device identified as a whole by 10 in the form of a shaping roller which is mounted on a screen 12 which may consist of nickel, for example. The screen 12 of the shaping roller 10 has over its entire outer circumference cavities 14 which are etched by means of a conventional galvanic process. These cavities 14 may have a more or less cylindrical basic shape, but any other shapes desired may also be etched. This particular characteristic shape is obtained by galvanic treatment of the cavities 14. The respective projections may be used to produce in a single operating step the interlocking means designated as a whole as 16 of a fastener element 18. For this purpose a free flowing plastic material in the plastic or liquid state is moved by a conventional method by means of a feeding device 20 in the form of an extruder to a gap 22 between the shaping roller 10 and a pressing device in the form of a press roller 24.

The shaping roller 10 and the press roller 24 are driven in opposite directions so that the plastic released from the extruder 20 may flow into the gap 22 between the rollers 10 and 24 and accordingly into the associated cavities 14. The plastic material present in the gap 22 forms a backing 26 with which the interlocking means 16 are integrated. At the same time, the distance between the two rollers 10 and 24 determines the width of the gap 22 and accordingly the thickness of the backing 26. The interlocking means 16 themselves are formed in that the plastic flows into the open cavities 14 of the screen 12 of the shaping roller 10, interlocking means 16 being formed in conjunction with the projections as described above in the cavities 14 by galvanic etching, interlocking means 16 which have stalks 28 on the ends of which facing away from the backing 26 there is formed an edge widened on all sides in the form of an enlargement or an interlocking head 30. The interlocking head 30 is suitable for interlocking with interlocking means of another fastener element not shown, for example, one in the form of a loop. The respective process of producing fastener elements is known, having been described in detail in DE 196 46 318 A1.

The production process as described in the foregoing is also particularly well suited for production of so-called microfastener material in which the interlocking means 16 are of very small geometric dimensions. A thermoplastic polyurethane material is used as plastic material for production of the interlocking means 16, including the backing 26, in the present embodiment. In order now to be able to reduce the thickness of the backing 26 in production of the interlocking means 16, provision is made, in addition to delivery of the plastic material to the gap 22, also for delivery of a support element 32 which is introduced between the press roller 24 and the plastic material of the backing 26, which it supports. Without the respective support element 32 the pressure applied by the press roller 24, which may be more than 1 t in the case of linear pressure, would suffice, if the backing 26 is sufficiently thin, to damage the backing. In contrast, the respective pressures applied by the support element 32 in question are uniformly absorbed and, surprisingly, in this way the backing 26 is relieved of application of damaging forces and may be designed to be very thin.

A plastic sheet, preferably a polyester sheet, polypropylene sheet, or polyamide sheet, may be used as the support element 32. A polyester foil is to be used in the present exemplary embodiment. The support element 32 may also consist of a thin metal foil such as aluminum foil or the like. In the embodiment illustrated the support element 32 is moved continuously in a closed circuit by way of deflection rollers 34, the direction of rotation of the deflection rollers 34 being indicated by arrows. If the support element 32 is in the form of polyester foil, practical experiments have shown it to be preferable to replace the polyester foil after use and to introduce fresh foil material at the point of delivery referred to above of the plastic material.

In addition to the deflection rollers 34 referred to a discharging roller 36 is provided which rotates in the same direction as the press roller 24, the discharging roller 36 serving the purpose of discharge of the interlocking means 16 from the cavities 14 of the shaping roller 10. In order to make the shapes of the interlocking heads 30 flatter, in particular in order to enlarge their edge, provision may be made such that the shaping process proper is followed by a calendering process in which two calender rollers 38 act, after the support element 32 has been discharged, on the rear side of the backing 26 and on the top of the interlocking heads 30. After the respective calendering process has been completed the fastener element 18 is then coiled by a conventional method not shown on shipping rollers for further shipping. After removal of the support element 32 in the form of polyester foil, however, provision may be made such that the fastener element 18 is removed immediately and undergoes the calendering process referred to at another operating station (not shown). If modern cone screens are employed rather than the simple structure of a screen 12, if desired the calendering may be dispensed with entirely.

In order to ensure joining of support element 32 to backing 26 in the shaping gap 22 free of friction and subsequent removal from the mould of the support element 32 of the backing 26 in the area of the lower deflection roller 34 as shown in the drawing, both the shaping roller 10 and the press roller 24 are heated. It has been found advisable to rotate the press roller 24 within a temperature range up to 130° C., preferably around 100° C., while the shaping roller 10 is rotated in a temperature range between 20° C. and 150° C., preferably at a temperature around 40° C. It has also been found to be advisable to select foil material, for example, in the form of polyester foil, for the support element 32, whose Shore A hardness as specified in DIN 53 304 [German Industrial Standard] is situated within a range of 80 to 89, preferably at 85. The extension elasticity of the backing foil as support element 32 may fall within the range of 0 to 5% in the case of a polyester foil, while the thermoplastic polyurethane material for the fastener element 18 has an extension elasticity ranging from 15% to 89%, both values being measured in accordance with Vickers with a test sample 1 mm thick and at room temperature.

The backing 26 in question and the support element 32 may be in the form of a strip in structure but may also be configured as a flat foil element. The respective extensible or elastic backing 26 may be designed to be very thin. If they possess the property of being elastic, the interlocking means 16 may be moved away from each other when force is applied, the backing 26 being further extended and, when the respective force is applied, the backing 26 returning the interlocking means 16 to their original positions because of the inherent elasticity of this backing 26. To this extent a fully elastic fastener element is provided by means of which a plurality of practical applications may be carried out.

If use is made of a polyester foil as support element 32, it is also possible to produce a reseparable fastening of support element 32 to the backing 26 during shaping. The respective retaining or adherent fastening then makes certain that the subsequent removal process in which the interlocking means 16 are removed from the cavities 14 of the shaping device 10 will proceed free of hindrance even if parts of the shaping device 10 extend under undercuts of the head material of the interlocking means 16. This configuration also permits conduct of the production process at a higher speed. In addition, it is possible in this way to produce small head elements and/or interlocking means 16 with very thick backings 26 (not shown). The polyester foil as support element 32 preferably remains on the backing 26 during the subsequent calendering process 38 in order thereby to have a positive effect on configuration of the head of the interlocking means 16. The support element 32 may be subsequently separated from the backing 26 and disposed of or recycled to the shaping device for a new processing step.

1. A method for producing a touch-and-close fastener element (18) having a plurality of interlocking means (16) designed to be integral with a backing (26), in which process a plastic material in a free flowing state is fed for the purpose of formation of the backing (26) to a gap (22) between a pressing device (24) and a shaping device (10) which is provided with cavities (14) for shaping of the respective interlocking means (16), characterized in that, in addition to feeding of the plastic material to the gap (22) there is also delivered to this gap (22) a support element (32) which provides support for the backing (26) between the pressing device and the plastic material, in such a way that during shaping the backing (26) is configured during shaping of the interlocking means (16) to be so thin that the backing (26) is provided with a predetermined extensibility or elasticity when use is made of a correspondingly suitable plastic material.

2. A process for production of a fastener element (18) having a plurality of interlocking means (16) designed to be integral with a backing (26), in which process a plastic material in a free flowing state is fed for the purpose of formation of the backing (26) to a gap (22) between a pressing device (24) and a shaping device (10) which is provided with cavities (14) for shaping of the respective interlocking means (16), characterized in that, in addition to feeding of the plastic material to the gap (22) there is also delivered to this gap (22) a support element (32) which provides support for the backing (26) between the pressing device (24) and the plastic material in such a way that the plastic periodically forms a reseparable fastening with support element (32) at least during shaping of the interlocking means (16).

3. The process as claimed in claim 1 or 2, wherein a plastic foil, preferably a polyester foil, polypropylene foil, or polyamide foil is used as the support element (32).

4. The process as claimed in claim 1 or 2, wherein a thin metal foil, preferably an aluminum foil, is used as the support element (32).

5. The process as claimed in one of claims 1 to 4, wherein the support element (32) in the form of a foil is reused in a closed circuit.

6. The process as claimed in one of claims 1 to 5, wherein interlocking heads (30), catch hooks, mushroom shapes, or preshapes such as stalks (28) are formed as interlocking means (16) during the shaping process.

7. The process as claimed in one of claims 1 to 6, wherein a calendering process (38) is carried out after the shaping process in which preferably shaping of the heads of the interlocking means (16) is effected.

8. The process as claimed in one of claims 1 to 7, wherein the plastic material introduced is a thermoplastic polypropylene material.

9. The process as claimed in one of claims 1 to 8, wherein a pressing and a shaping roller rotating in opposite directions are used as the pressing (10) and the shaping device (12), and wherein the respective rollers (10, 12) are heated for the shaping process.
